(19) United States
(12) Patent Application Publication
(10) Pub. No.: US 2011/0233958 A1
(43) Pub. Date: Sep. 29, 2011

(54) See thru sun visor

(76) Inventor: Cindy Rhine, Alna, ME (US)

(21) Appl. No.: 13/065,595

(22) Filed: Mar. 24, 2011

Related U.S. Application Data
(60) Provisional application No. 61/340,969, filed on Mar. 25, 2010.

(51) Int. Cl. B60J 3/06; B60J 3/00

(52) U.S. Cl. 296/97.1

(57) ABSTRACT

The present invention provides a See Thru Sun Visor, designed to replace any existing sun visor in order to provide sun blocking protection without obstructing the driver's view of the road comprising primarily heavy duty plastic, the See Thru Sun Visor is a see-through unit which features a smoky tinted plexiglass or shatterproof optical glass material, which filters the sun's harmful ultraviolet rays. Rectangular in shape, the See Thru Sun Visor measures the approximate length of standard visors and several inches in width. The device can be packaged in a kit and comes pre-assembled with the See Thru Sun Visor attached to the arm for easy installation. Simply remove the existing sun visor arm and install the See Thru Sun Visor. Both the driver and passenger side See Thru Sun Visor can be packaged and sold as a set, to be installed by the vehicle owner.

### CLAIM OF PRIORITY

This patent application claims priority under 35 USC 119 (e) (1) from U.S. Provisional Patent Application Ser. No. 61/340,969 filed Mar. 25, 2010, of common inventorship herewith entitled, “See thru sun visor.”

### FIELD OF THE INVENTION

The present invention pertains to the field of vehicle safety devices, and more specifically to the field of vehicle sun visor devices.

### BACKGROUND OF THE INVENTION

The prior art has put forth several designs for vehicle sun visor devices. Among these are:

U.S. Pat. No. 4,352,519 to Ernesto M. Aro describes an automotive vehicle sun visor with an improved glare shield in which a flat sheet of glare reducing plastic is hinged to a backing and secured to the sun visor by means of metal clips inserted in the backing.

U.S. Pat. No. 5,040,840 to Theodor Kokeisl describes a motor vehicle tinted translucent glare protection shield that is adjustably held by a guide rail for adjusting the elevation of the shield, which is also tiltable around an axis.

U.S. Pat. No. 6,439,638 to Teruo Kawasaki, et al. describes a sun visor to be used in a vehicle which has a sun visor body with an opening.

None of these prior art references describe the present invention.

### SUMMARY OF THE INVENTION

It is an object of the present invention to provide an improved vehicle sun visor device.

### BRIEF DESCRIPTION OF THE DRAWINGS

FIG. 1 is a rear angled perspective view of the device of the present invention installed in a motor vehicle.

FIG. 2 is a rear angled perspective view of the device of the present invention installed in a motor vehicle in an extended configuration.

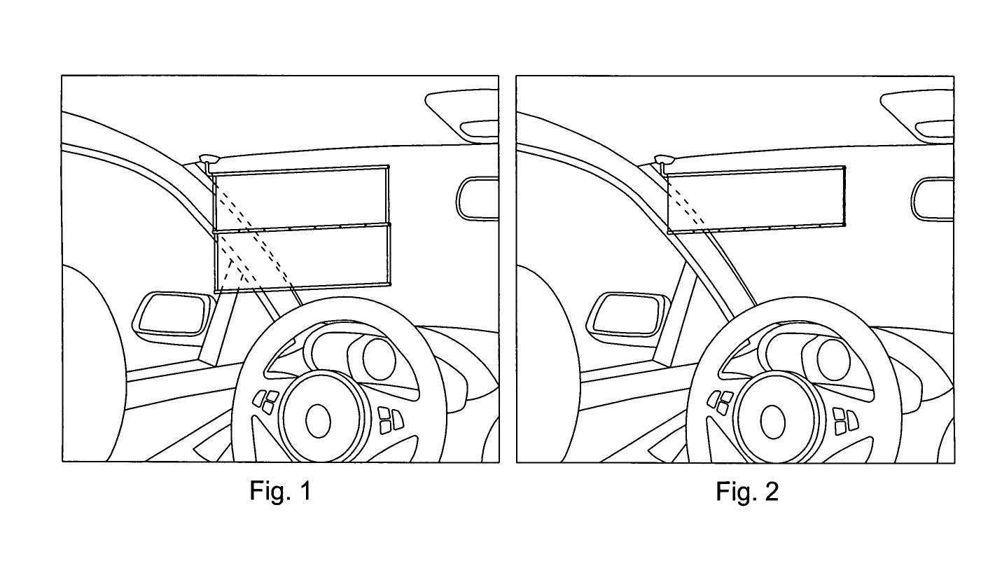

### DETAILED DESCRIPTION OF THE INVENTION

Everyday, millions of consumers climb into their automobiles and head off for a day of work, school, or recreation. Whether a busy executive traveling to an important business luncheon, a homemaker dropping the kids off at a school dance, or a professional delivery man making his rounds, automobiles offer consumers a simple and efficient means of traveling from one destination to the next. Most considerate drivers realize the importance of staying alert behind the wheel and because of this pay close attention to the comings and goings of traffic, their speed, road signs and stop lights.

Unfortunately, as many drivers attest, there are obstacles that even the most conscientious of drivers cannot avoid. In particular, driving in the direction of sunlight is both difficult and dangerous. Causing unavoidable “blind spots”, the glare of intense sunlight makes it almost impossible to see the road ahead. Resulting in low-contrast vision, glare from the sun is distracting and directly affects driving comfort and safety. Burning the eyes and causing fatigue and strain, the blinding glare caused by ultraviolet rays make even the shortest of journeys exhausting and stressful. Most consumers attempt to solve this problem by utilizing a sun visor. Sun visors are a standard feature in all cars and trucks and offer the driver a simple means of reducing glare and shading their eyes. Although sun visors are a practical accessory, they are not always effective. Blocking only the very top portion of the windshield, most sun visors still allow ample sunlight to enter the car.

The present invention, hereinafter referred as the See Thru Sun Visor, is designed to replace any existing sun visor in order to provide sun blocking protection without obstructing the driver's view of the road.

Manufactured primarily of heavy duty plastic, the See Thru Sun Visor is a see-through unit which features a smoky tinted plexiglass™ or shatterproof polarized optical glass material, which filters the sun's harmful ultraviolet rays. Rectangular in shape, the See Thru Sun Visor measures the approximate length of standard visors and several inches in width. The device can be packaged in a kit and comes pre-assembled with the See Thru Sun Visor attached to the arm for easy installation. Simply remove the existing sun visor arm and install the See Thru Sun Visor. Both the driver and passenger side See Thru Sun Visor can be packaged and sold as a set, to be installed by the vehicle owner.

Use of the See Thru Sun Visor is very simple and straightforward. First, the user secures the See Thru Sun Visor to their automobile. Once properly installed, the user utilizes the See Thru Sun Visor by flipping the visor downwards, thus allowing the sun blocking material to filter out the sun's harmful rays. After use, the See Thru Sun Visor is flipped closed and the driver goes about their scheduled activities.

The See Thru Sun Visor is a unique product invention which offers consumers many significant benefits and advantages. Foremost, this cleverly designed product provides those driving or riding in the front seat of automobiles, a comfortable means of viewing the road. Eliminating the blinding glare caused by overhead sunlight, this practical product ensures that drivers safely see the road ahead, even on the sunniest of afternoons. Blocking the sun's harmful ultraviolet rays, use of the See Thru Sun Visor protects the eyes from potentially dangerous overexposure to the sun. Additionally, because the See Thru Sun Visor effectively protects the eyes from glare and sunlight, use of this product greatly reduces the eye and body fatigue associated with heat and glare. Another important advantage is that the See Thru Sun Visor offers several more inches of sun blocking protection than standard auto visors. Enabling drivers to clearly view the road, even when facing the setting sun, this visor extension proves particularly useful to those of short stature. Providing an effective sun blocker, regardless of the height of the driver, this cleverly designed visor enables those who typically are too short to benefit from standard visors, a simple means of viewing the road.

Although designed with the general consumer in mind, the See Thru Sun Visor is an invaluable accessory for those who drive professionally. City bus drivers, cabbies, truckers and delivery personnel all appreciate the many benefits this useful product affords. Durable, the See Thru Sun Visor withstands years of repeated use.

Reducing glare and blocking ultraviolet rays, the See Thru Sun Visor is a practical product invention which offers consumers a safe and comfortable means of driving in the sun. Simple to install and durably constructed, this unique product is a valuable accessory for anyone who operates a motor vehicle.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A vehicle sun visor device, comprising a transparent sun visor designed to replace any existing sun visor comprising heavy duty plastic, wherein the device measures the approximate length of standard visors and several inches in width.

2. The device of claim 1 comprised of smoky tinted plexiglass™ material.

3. The device of claim 1 comprised of shatterproof optical polarized glass material, which filters the sun's harmful ultraviolet rays.

4. The device of claim 1 packaged in a kit and comes pre-assembled with the See Thru Sun Visor attached to the arm for easy installation.

5. The device of claim 1 packaged in a set comprising a sun visor for the driver's side and for the passenger side as a set.

6. The packaged set of claim 5 to be installed by the vehicle owner.
